(19) United States
(12) Patent Application Publication
(10) Pub. No.: US 2009/0212506 A1
(43) Pub. Date: Aug. 27, 2009

(54) TOOL HOLDER

(75) Inventor: Bo Goran Johansson, Bredared (SE)

Correspondence Address: GAUTHIER & CONNORS, LLP, 225 FRANKLIN STREET, SUITE 2300, BOSTON, MA, 02110, US

(73) Assignee: IGEMS SOFTWARE AB, Boras (SE)

(21) Appl. No.: 12/112,342

(22) Filed: Apr. 30, 2008

(30) Foreign Application Priority Data
Feb. 25, 2008 (SE) 0800438-4

(51) Int. Cl. B23B 31/36

(52) U.S. Cl. 279/5

(57) ABSTRACT

The present invention relates to a tool holder, adapted to hold a tool for working at least a portion of a work piece, which portion extends substantially in a plane. The tool has a working tip which is located in an apex position of the tool holder when the tool holder holds the tool. The tool holder comprises an arm which is pivotable around a first axis of rotation and a fastening device adapted to carry the tool. The fastening device is connected to the arm and the tool is pivotable around a second axis of rotation when the fastening device carries the tool.

### PRIORITY INFORMATION

The present application claims priority to Swedish Application Serial No. SE0800438-4, filed on Feb. 25, 2008, which is incorporated herein by reference in its entirety.

### TECHNICAL FIELD

The present invention relates to a tool holder, adapted to hold a tool for working at least a portion of a work piece, which portion extends substantially in a plane. The tool has a working tip which is located in an apex position of the tool holder when the tool holder holds the tool. The tool holder comprises an arm which is pivotable around a first axis of rotation and a fastening device adapted to carry the tool. The fastening device is connected to the arm and the tool is pivotable around a second axis of rotation when the fastening device carries the tool.

### BACKGROUND OF THE INVENTION

When working a work piece, in particular when working by cutting, a working tool is often used which is conducted over the work piece. This working tool is usually attached to an adjusting device which is adapted to tilt and/or move the tool relative to the work piece. Quite often, the adjusting device is constituted by a tool holder, adapted to tilt the tool relative to the work piece, which tilt preferably may occur around at least two axes of rotation, and a control device which is adapted to move the tool holder relative to the work piece. Usually, the control device is adapted to perform a translation, i.e. a move without rotation, of the tool holder relative to the work piece. An example of such an adjusting device is illustrated in U.S. Pat. No. 6,705,921 B1. With an adjusting device like the one illustrated in U.S. Pat. No. 6,705,921 B1, the position of the tool relative to the work piece may be controlled by the control device while the tilt of the tool is controlled by the tool holder. Thus, in the case when the working tool is a cutting tool, for example, a chamfered edge of a work piece may be achieved in a simple manner.

However, in many types of working, for instance in water cutting, it is preferred that the vertical distance, that is the distance in the normal direction of the work piece, between the tip of the working tool and the work piece may be controlled with small tolerances. Moreover, it is often desirable that the vertical distance may be kept constant during at least parts of the working. This constant distance is desirable since the vertical distance between the tip and the work piece effects the working cut, for example in terms of the quality and position of the cut.

Therefore, it would be desirable to provide an adjusting device, which can ensure accurate and rapid control of the vertical distance between the tip of the working tool and the work piece. It would be even more desirable to provide an adjusting device which can ensure that the above-mentioned vertical distance is maintained throughout the working.

In order to achieve an adjusting device which ensures rapid and accurate control of the above-mentioned vertical distance, WO 2005/035183 A2 proposes an adjusting device having a tool holder in the form of a hemisphere, in which hemisphere the working tool may be conducted to thus be able to be tilted around two axes of rotation without changing the vertical distance between the tip of the working tool and the work piece which is to be worked. However, there are some disadvantages with the tool holder according to WO 2005/035183 A2. Among others, the tool holder only allows small tilt deflections of the tool and it may furthermore be difficult and costly to obtain a tool holder which provides appropriate tolerances of the tilt of the tool since this makes great demands upon the design of the sphere. Furthermore, the tool holder according to WO 2005/035183 A2 may be sensitive to dirt and working spills and it may be difficult to change tool in the tool holder. Further, the hemispherical design of the tool holder results in that it may be difficult to find a horizontal neutral position for the tool since the hemisphere covers the tool, and also that this results in a limitation of space for the tool, that is it may be difficult to work an area which is for example close to walls since the tool holder would then hit the wall a long time before the tool reaches the wall. In addition to this, as previously mentioned, the tool holder is often used in conjunction with a so called height sensor adapted to measure the vertical distance between the work piece and the tool. The location of such a height sensor is made difficult by the above-mentioned design of the tool holder.

As is realized by the exposition hereinabove, there is a need for further development of tool holders.

### SUMMARY OF THE INVENTION

A first object of the present invention is to provide a tool holder wherein a change of the tilt of the tool may be achieved by a change with a corresponding magnitude of the position of the tool holder.

A second object of the present invention is to provide a tool holder which may tilt a tool around at least two axes of rotation without having any limitation in the rotation.

A third object of the present invention is to provide a tool holder which in an efficient manner may be used together with a height sensor.

A fourth object of the present invention is to provide a tool holder which does not necessarily require a accurate placement of a tip of the tool which is to be held by the tool holder but which nevertheless may provide an appropriate quality of the working result.

A fifth object of the present invention is to provide a tool holder which may achieve large tilts of the tool around at least two axes of rotation.

A sixth object of the present invention is to provide a tool holder which may be used on already existing machines, such as for example a converting system.

At least one of the above objects is achieved by a tool holder according to claim 1.

Thus, the present invention relates to a tool holder, adapted to hold a tool for working at least a portion of a work piece, which portion extends substantially in a plane, wherein the tool has a working tip which is located in an apex position of the tool holder when the tool holder holds the tool. The tool holder comprises an arm which is pivotable around a first axis of rotation and a fastening device adapted to carry the tool, wherein the fastening device is connected to the arm and the tool is pivotable around a second axis of rotation when the fastening device carries the tool. According to the invention, the tool holder is designed such that:
each one of the first and second axes of rotation has a component which is parallel to the plane, and that
each one of the first and second axes of rotation extends through the apex position.

The meaning of the expression “working tip” in the present invention is explained in the description in conjunction with FIG. 2B.

Since the tool holder according to the present invention results in that a tool which is attached in the tool holder may be tilted around two axes of rotation which both extend through the apex position of the tool holder, this results in that the working tip of the tool will not move substantially vertically or laterally when the tilt of the tool is changed. This is advantageous since it reduces, and often even completely eliminates, the need for adjusting the position of the tool holder after the tilt of the tool has been changed.

Further, since both the axes of rotation have a component which is in the plane of the work piece, this enables that the tool may be tilted without rotating the tool. This feature gives the possibility to place for example conduits around the tool in a simple way. Working of a rotation geometry or a helix having tilted sides may therefore be carried out by means of tilts of the tool rather than rotations of the same.

In addition to the above, it could also be mentioned that since both the axes of rotation have a component in the plane of the work piece, this results in that a change, be it small, of the tilt of the tool always may be accomplished by a corresponding change, i.e. a change in the same order of magnitude, of the position of the tool holder, namely a tilt of the arm and/or the fastening device.

Additionally, the tool holder according to the present invention may preferably be used on already existing machines since the invention provides a possibility of an appropriate connection being made between the tool and the rest of the machine.

In a preferred embodiment of the present invention, the fastening device comprises a slewing bracket arrangement which in turn comprises: a slewing bracket which is pivotably connected to the arm about an axis of rotation which is substantially perpendicular to the first axis of rotation, a fastening part adapted to carry the tool and a connecting part which pivotally connects the slewing bracket and the fastening part.

The slewing bracket arrangement according to the above is an appropriate implementation of a pivotable fastening device, which arrangement is also simple and cost efficient to manufacture and install.

In another embodiment of the present invention, the slewing bracket is pivotally connected to the arm at the first axis of rotation. This location of the pivotable connection ensures that the first and second axes of rotation coincide in the apex position.

In a further embodiment of the present invention, the slewing bracket arrangement comprises a plurality of slewing brackets. When the slewing bracket arrangement comprises a plurality of slewing brackets, a robust and safe tool holder is obtained.

In yet a further embodiment of the present tool, the fastening device comprises an arcuate guide rail which is fixedly attached to the arm. The guide rail is further adapted to carry the tool such that the tool is slidably attached to the guide rail.

In another embodiment of the present invention, the tool is a water cutting tool.

In a further embodiment of the present invention, the tool holder further comprises a meter adapted to establish the distance between the apex position and the work piece. Such a meter is often denoted a height sensor.

A second aspect of the present invention relates to a converting assembly, comprising a tool holder according to the above and means for transferring the tool holder relative to the work piece.

In a preferred embodiment of the present invention, the means is adapted to translate the tool holder in relation to the work piece. As used herein, the expression “translate” relates to a move without a tilt.

A third aspect of the invention relates to a converting system, comprising a tool holder according to the first aspect of the present invention and/or a converting assembly according to the second aspect of the present invention.

A fourth aspect of the present invention relates to a method of working at least a portion of a work piece with a converting assembly, which portion extends substantially in a plane and which converting assembly comprises a tool holder and a tool. The tool has a working tip which is located in an apex position of the tool holder when the tool holder holds the tool. The tool holder comprises an arm and a fastening device and the method according to the fourth aspect of the present invention comprises the steps of:
tilting the tool around a first axis of rotation, and/or
tilting the tool around a second axis of rotation.

According to the fourth aspect of the present invention, the above tilts are carried out such that:
each one of the first and second axes of rotation has a component which is parallel to the plane, and that
each one of the first and second axes of rotation extends through the apex position.

In a preferred embodiment of the fourth aspect of the present invention, the step of tilting the tool around the first axis of rotation is achieved by a pivot of the arm.

In a further embodiment of the fourth aspect of the present invention, the step of tilting the tool around the second axis of rotation is achieved by a pivot of the fastening device relative to the arm.

### BRIEF DESCRIPTION OF THE DRAWINGS

The present invention will below be explained by means of non-limiting examples with reference to the appended drawings, wherein:

FIG. 1 is a schematic perspective view of a converting system according to the present invention;

FIG. 2A is a schematic perspective view of an embodiment of a tool holder according to the present invention;

FIG. 2B is a side view of a tool in two different tilts, wherein the definition of the working tip according to the present invention is illustrated;

FIG. 3 is a schematic perspective view of another embodiment of the tool holder according to the present invention, and

FIG. 4 is a schematic perspective view of yet another embodiment of the tool holder according to the present invention.

### DETAILED DESCRIPTION OF PREFERRED EMBODIMENTS

The invention will be described by means of examples of embodiments. However, it should be realized that these embodiments only serve the purpose to clarify the present invention, whose scope of protection is limited by the appended claims.

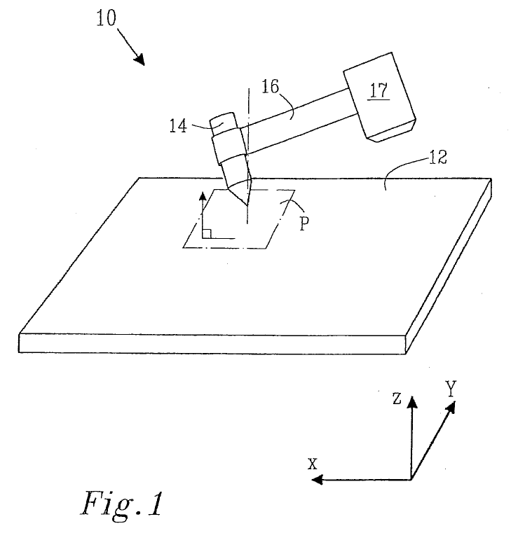

FIG. 1 illustrates a converting system 10 according to the invention for working a work piece 12 with a tool 14. At least a portion of the work piece 12 extends substantially in a plane P, which plane in the example illustrated in FIG. 1 extends along an X and a Y dimension. In FIG. 1, the whole work piece 12 extends in the plane P. The tool 14 maybe of various kinds, for example the tool 14 may be a cutting tool which utilizes for instance plasma cutting, laser cutting or water cutting. In the case of water cutting, the tool may preferably be connected to a high pressure pump (not shown) adapted to generate a water pressure, which flows through a nozzle of the tool.

In the case of a water cutting tool, this may also comprise means (not shown) for supply of abrasive which is mixed with the water flowing through the nozzle to thereby increase the cutting effect of the water beam. As a non-limiting example, it can be mentioned that the water pressure of a water cutting tool of today may amount to 3600-4100 bars and the flow velocity of the water leaving the nozzle of the tool may reach 900 m/s. However, there are already attempts to increase the above-mentioned pressure to approximately 8000 bar.

The system 10 further comprises a tool holder 16 adapted to hold the tool 14 and means for moving the tool holder 16 relative to the work piece 12. Preferably, this relative displacement is achieved as a translation, that is a displacement without rotation. This means is in FIG. 1 illustrated by a drive unit 17 adapted to move the tool holder in the X, Y and Z directions relative to the work piece 12. However, it is of course possible to accomplish this means in other ways, for instance the work piece 12 may be arranged on a carrying unit (not shown) which may be moved in for example the X, Y and Z directions while the tool holder 16 remains stationary. Of course, the means may also accomplished by a combination of the above possibilities, such that both the tool holder 16 and the work piece 12 can move in the X, Y and Z directions.

The tool holder 16 is adapted to tilt the tool 14 around at least two, non-parallel, axes of rotation. When the tool can be tilted around exactly two axes of rotations and combinations thereof, the system 10 is sometimes referred to as a five-axis converting system wherein the two axes of rotation constitute two of the axes and the directions of translations, that is the X, Y and Z directions, constitute the remaining three axes.

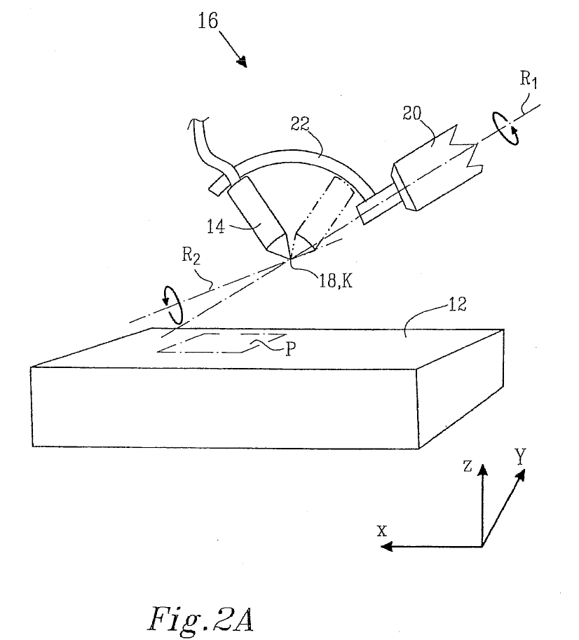

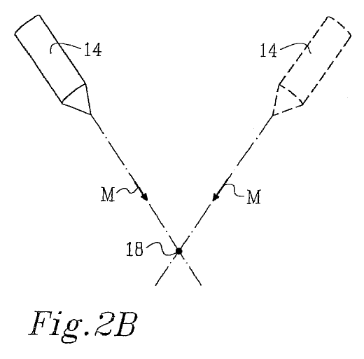

FIG. 2A illustrates an embodiment of the tool holder 16 according to the present invention. As realized from FIG. 2A, the tool 14 has a working tip 18. By working tip 18 is herein meant the part of the tool wherein the working part of the tool is located and/or where a working medium is discharged from the tool. Thus, in the case with water cutting, this tip may be constituted by the nozzle through which the pressurized water flows while in the case of for example laser cutting it may be constituted by the orifice of the tool out of which orifice the laser beam leaves the tool.

However, it should be pointed out that in the case when the tool 14 uses a working medium, such as for example a water, laser or plasma beam, which is fed out from the tool in a feeding direction M from the tool 14 to the work piece 12 which is to be worked, the working tip 18 may in this case be located in a position outside the tool, along the aforesaid feeding direction M. An example of such a case is illustrated in FIG. 2B illustrating a tool 14 in two positions—wherein a first position is illustrated by solid lines and a second position is illustrated by dashed lines. As realized from FIG. 2B, the working tip 18 is located outside the tool 14 but in a prolongation of the tool 14 in the feeding direction M and as further realized from FIG. 2B the working tip 18 is located in the same position irrespective of whether the tool 14 is located in the first or second position. It is the latter effect which is desired to be achieved by a tool holder 16 according to the present invention, namely that the working tip 18 does not substantially move during a change in the tilt of the tool 14 relative to the work piece 12.

FIG. 2A further illustrates that the working tip 18 is located in an apex position K of the tool holder 16 when the tool holder 16 holds the tool 14. FIG. 2A further illustrates that the tool holder 16 comprises an arm 20 which is pivotable around a first axis of rotation R₁ and a fastening device 22 arranged to carry the tool 14.

The fastening device 22 is in FIG. 2A constituted by an arcuate guide rail on which the tool 14 is slidably arranged, which is a preferred implementation of the fastening device 22 according to the invention. FIG. 2A also illustrates, with dashed and dotted lines, the tool 14 in a second position. In a comparison between the first position, which is illustrated by solid lines, and the second position it is realized that the tool has been pivoted or tilted around a second axis of rotation R₂. As may be gleaned from FIG. 2A, neither the first nor the second axis of rotation is perpendicular to the plane P in which the work piece 12 extends and in the position of the tool holder 16 illustrated in FIG. 2A, the second axis of rotation R₂ is in fact parallel to the plane P. In other words, each one of the first and second axes of rotation R₁, R₂ has at least a component which is parallel to the plane P. As is further evident from FIG. 2A, both the axes of rotation R₁, R₂ extend through the apex position K. This results in that the position of the tip 18 of the tool 14 will not be changed during the rotation from the first position to the second position. It is further realized from FIG. 2A that the position and the design of the guide rail results in that the second axis of rotation R₂ is substantially parallel to the first axis of rotation R₁.

The tool holder 16 according to the present invention further preferably comprises means for achieving a change of the tilt of the tool 14 around the first or second axis of rotation R₁, R₂. Examples of such means may be an actuator (not shown) adapted to rotate the arm 20 around the first axis of rotation R₁ and a further actuator (not shown) adapted to displace the tool 14 along the arcuate guide rail of the fastening device 22 in FIG. 2A. Of course, the above mentioned means may also be used for simultaneously tilting the tool around both the first and second axis of rotation R₁, R₂. A tool 14 which is attached to the tool holder 16 according to FIG. 2A may preferably be tilted at least ±45° around each axis of rotation. A further advantage of the tool holder 16 according to the present invention is that it does not require an extremely accurate placement of the tool 14 in the tool holder 16 for the working to function in an appropriate manner. As an example, it can be mentioned that the tool 14 in several cases may be placed with its working tip 18 with a tolerance of ±0.1 mm from the apex position K and still achieve working of a requisite quality.

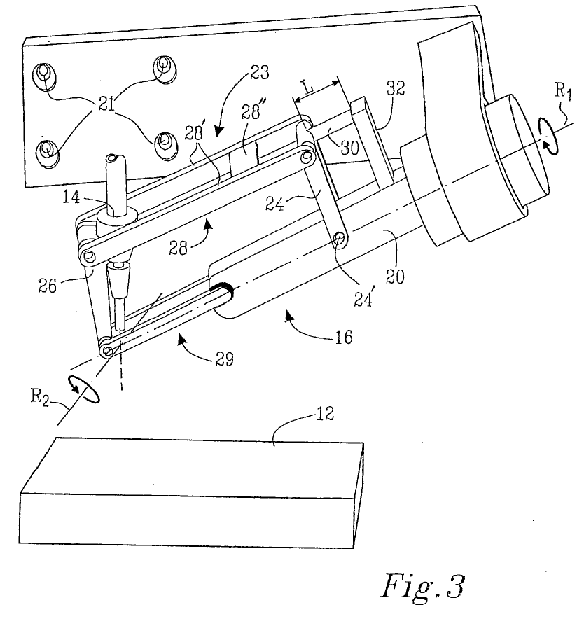

FIG. 3 illustrates a preferred embodiment of the tool holder 16 where the fastening device 22 comprises a slewing bracket arrangement 23. This slewing bracket arrangement 23 in turn comprises a slewing bracket 24 which is pivotably connected to the arm 20 and a fastening part 26 adapted to carry the tool 14. Further, the slewing bracket arrangement 23 comprises a connecting part 28 which pivotally connects the slewing bracket 24 and the fastening part 26. The slewing bracket 24 in FIG. 3 is substantially U-shaped wherein each one of the legs of the U-shaped slewing bracket is pivotally attached to the arm 20. This pivotable attachment is preferably achieved by means of for instance axel journals (not shown) of the arm 20 which extend into openings 24′ of the slewing bracket 24. However, in some applications the pivotable attachment may be achieved in other ways, such as by means of ball joints (not shown) or a shaft (not shown) extending through the arm the ends of which arm protrudes into the openings 24′.

FIG. 3 further illustrates a preferred implementation of the slewing bracket 24, wherein the pivotable attachment between the slewing bracket 24 and the arm 20 is located at the first axis of rotation R₁. By this placement of the attachment, it is ensured that the first and second axes of rotation R₁, R₂ intersect at the apex point K. Further, the tool holder preferably comprises means for attaching the tool 16 to a control device (not shown) of a converting system (not shown in FIG. 3). In FIG. 3, this attachment means is illustrated by bolt holes 21 such that the tool holder 16 may be attached to the control device by means of a bolt joint (not shown).

The fastening part 26 is as previously mentioned adapted to carry the tool 14. To this end, the fastening part 26 preferably comprises a fastening arrangement, such as for instance a screw joint or a snap-on device (not shown), in order to ensure that the tool 14 is properly attached to the fastening part 26 during use.

Further, FIG. 3 illustrates a preferred implementation of the connecting part 28 wherein this comprises two elongate connection portions 28′ which are attached to one another by means of a cross bar 28″, which connection portions 28 are each pivotably connected to one leg each of the slewing bracket 24. In the same manner as for the connection between the slewing bracket 24 and the arm 20, the pivotable connection between each connection portion 28′ and the corresponding leg of the slewing bracket 24 may be achieved for example by means of axel journals or ball joints (not shown). The same also applies for the pivotable connections between each connection portion 28′ and the fastening part 26.

In a similar way as discussed in connection with the embodiment illustrated in FIG. 2A, the tool holder 16 illustrated in FIG. 3 may preferably be provided with means for achieving a rotation of the arm 20 around the first axis of rotation R₁. Furthermore, the embodiment of the tool holder 16 illustrated in FIG. 3 preferably comprises means for tilting the tool 14 around the second axis of rotation R₂. As an example of such a means, an actuator 30 can be mentioned which actuator is adapted to change the distance L between an attachment point 32 for the actuator on the arm 20 and a portion of the slewing bracket arrangement 23. When the distance L is varied, the tilting of the tool 14 also will be changed. Preferably, the embodiment of the tool holder 16 illustrated in FIG. 3 also comprises a pivotable connection between the lower part, i.e. the part closest to the work piece 12 which is to be worked, of the fastening part 26 and the tool holder 16. In FIG. 3, this connection is exemplified by a strut 29 which is fixedly attached to the arm and pivotally connected to the lower part of the fastening part 26. This pivotable connection between the fastening part 26 and the tool holder 16 facilitates the tilting of the tool 14 when the distance L is changed. However, in other embodiments of the tool holder 16 illustrated in FIG. 3 the pivotable connection could be achieved in other ways, for example by means of a connection (not shown) between the portion of the tool holder 16 being located at the openings 21 and the lower part of the fastening part 26.

In a similar way as discussed in conjunction with FIG. 2A, the above mentioned means may be used for achieving a tilt around both the first and second axes of rotation R₁, R₂. The implementation of the slewing bracket arrangement 23 also enables that the tool 14 may be imparted a large tilt around both the first and second axes of rotation R₁, R₂. A tool 14 which is attached to the tool holder 16 by means of a slewing bracket arrangement according to the embodiment illustrated in FIG. 3 may preferably be tilted at least ±45° around each one of the axes of rotation.

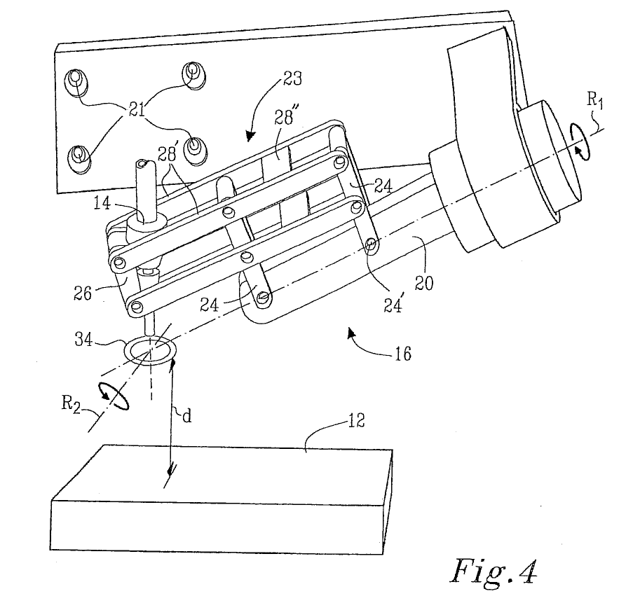

Both the means of achieving the rotation of the arm 20 and the means for achieving the tilt of the tool 14 around the second axis of rotation R₂ are preferably in communication with a control system (not shown) adapted to control the above mentioned displacements, this applies for all the embodiments of the tool holder according to the present invention. The connections between the above mentioned means and the control system may for example be hydraulic, pneumatic or electric, dependent on the application of the tool holder. Furthermore, the control system may in itself comprise means for receiving and storing instructions as regards the position of the tool holder, for example via a CNC-file. FIG. 4 illustrates a preferred implementation of the slewing bracket arrangement 23 wherein this comprises a plurality of slewing brackets 24 and connection parts 28, in this case two of each. FIG. 4 further illustrates a preferred embodiment of the tool holder 16, wherein this comprises a meter 34 adapted to establish the distance d between the apex position K and the work piece 12. The meter 34 is often denoted a height sensor and preferably comprises a ring, the position of which is controlled by pressurized air which is to conducted towards the work piece 12. Dependent on the position of the ring, the distance d between the apex position K and the work piece 12 may be set.

The two slewing brackets in FIG. 4 are located at a distance from one another along the first axis of rotation R₁ and each one is pivotally connected to the two connection parts 28 which in turn are located at a distance from one another in a direction which is substantially parallel to the first direction of rotation R₁.

It is realized that the present invention is not limited to the embodiments described above and illustrated in the drawings; rather a person skilled in the art will detect many alterations and modifications that can be performed within the frame of the scope of protection of the appended claims.

1. A tool holder, adapted to hold a tool for working at least a portion of a work piece, which portion extends substantially in a plane, wherein said too has a working tip which is located in an apex position of said tool holder when said tool holder holds said tool, wherein said tool holder comprises an arm which is pivotable around a first axis of rotation and a fastening device adapted to carry said tool, wherein said fastening device is connected to said arm and said tool is pivotable around a second axis of rotation when said fastening device carries said tool, characterized in that:
each one of said first and second axes of rotation has a component which is parallel to said plane, and that
each one of said first and second axes or rotation extends through said apex position.

2. The tool holder, according to claim 1, wherein said fastening device comprises a slewing bracket arrangement which in turn comprises: a slewing bracket which is pivotably connected to said arm about an axis of rotation which is substantially perpendicular to said first axis of rotation, a fastening part adapted to carry said tool and a connecting part which pivotally connects said slewing bracket and said fastening part.

3. The tool holder according to claim 2, wherein said slewing bracket is pivotally connected to said arm at said first axis of rotation.

4. The tool holder according to claim 2, wherein said slewing bracket arrangement comprises a plurality of slewing brackets.

5. The tool holder according to claim 1, wherein said fastening device comprises an arcuate guide rail which is fixedly attached to said arm, wherein said guide rail further is adapted to carry said tool such that said tool is slidably attached to said guide rail.

6. The tool holder according to claim 1, wherein said tool is a water cutting tool.

7. The tool holder according to claim 1, wherein said tool holder further comprises a meter adapted to set the distance between said apex position and said work piece.

8. A converting assembly, comprising a tool holder according to claim 1, a tool and means for transferring said tool holder relative to said work piece.

9. The converting assembly according to claim 8, wherein said means is adapted to translate said tool holder in relation to said work piece.

10. A converting system, comprising a tool holder according to claim 1 and/or a converting assembly according to claim 8.

11. A method of working at least a portion of a work piece with a converting assembly, which portion extends substantially in a plane and which converting assembly comprises a tool holder and a tool, wherein said tool has a working tip which is located in an apex position of said tool holder when said tool holder holds said tool, wherein said tool holder comprises an arm and a fastening device, wherein the method comprises the steps of:
tilting the tool around a first axis of rotation, and/or
tilting the tool around a second axis of rotation,
wherein,
each one of said first and second axes of rotation has a component which is parallel to said plane, and that
each one of said first and second axes of rotation extends through said apex position.

12. The method according to claim 11, wherein the step of tilting the tool around said first axis of rotation is achieved by a pivot of said arm.

13. The method according to claim 11, wherein the step of tilting said tool around said second axis of rotation is achieved by a pivot of said fastening device relative to said arm.
